(19) United States
(12) Patent Application Publication
(10) Pub. No.: US 2008/0144451 A1
(43) Pub. Date: Jun. 19, 2008

(54) Information Reproduction Apparatus, Information Reproduction Method, Information Reproduction Program, And Recording Medium Having Information Reproduction Program Recorded On It

(76) Inventor: Shinnosuke Fukuda, Saitama (JP)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/886,069

(22) PCT Filed: Mar. 28, 2006
(86) PCT No.: PCT/JP2006/306241

§ 371 Date: Sep. 11, 2007

(30) Foreign Application Priority Data
Mar. 31, 2005 (JP) 2005-103670

(51) Int. Cl. G11B 7/09

(52) U.S. Cl. 369/44.25

(57) ABSTRACT

An information reproducer in which not only the accuracy at the time of reading a signal but also the stability of a servo circuit are enhanced by adding a servo error signal to parameters for judging acceptability of a data signal in an optical disc. An information reproduction method, an information reproduction program and an information recording medium having such program recorded therein are also provided. A light receiving means is moved in the radial direction of the recording medium and, in the radial direction of the recording medium determined by such movement in the radial direction, the light receiving means is moved in the focus direction substantially orthogonally crossing the surface of the recording medium. An electric signal created from light received by the light receiving means moved in the focus direction is then operated and the electric signal value (offset value) in the radial direction is determined based on the symmetry of the electric signal in the operated moving direction of the light receiving means.

### TECHNICAL FIELD

The present invention relates to a technical field of controlling an optical disc information reproduction apparatus.

### BACKGROUND ART

In an optical disc such as CD (Compact Disc), MD (Mini Disc), and DVD (Digital Versatile Disc), it is known that a servo circuit for controlling to place an optical pick-up or an objective lens included in an optical pick-up at an appropriate position is necessary for recording or reading out information on an information recording layer having the information recorded on it or an information reproducing layer having the information to be reproduced on it.

In a tracking servo circuit among such the servo circuits, a focal point of objective lens is adjusted to be placed at a most suitable position with respect to the information layer by electrically applying a predetermined direct current to a tracking actuator for controlling the position of the objective lens.

For example, it is known in the optical disc record and reproduction apparatus as a method of obtaining a predetermined direct current value as a most suitable offset voltage value by writing information at a predetermined area of an optical disc while moving the objective lens in a radius direction of the optical disc, and similarly reading out information thus written while moving the objective lens in the radius direction of optical disc. (for example Patent Document 1)

According to the method, in a case where an objective lens of an optical pickup is deviated from an optic axis, it is possible to record and reproduce information without deteriorating recording signal quality and reproducing signal quality in recording and reproducing the information. Patent Document 1: Japanese Unexamined Patent Publication 2002-304752

However, according to the above method, a predetermined voltage to be applied to a tracking actuator at a time of reproducing is determined by determining a predetermined voltage to be applied to the tracking actuator at a time of recording. Further, on the basis of a signal quality at the time of reproducing, a predetermined voltage to be applied to the tracking actuator is determined. Therefore, there is a problem that the information cannot be read out with a stable servo control since quality of servo signal at the time of reproduction is not sufficiently evaluated.

### DISCLOSURE OF THE INVENTION

Therefore, the present invention is provided in light of the above inconvenience, and an example of its object is to provide an information reproduction apparatus, an information reproduction method, an information reproduction method, an information reproduction program, and an information recording medium having the information reproduction program recorded on it, which have not only accuracy in reading out signals but also improved stability of servo circuit and further improved reliability and accuracy in reading out signals in comparison with a conventional technique by adding a servo error signal to judgment parameters of judging whether data signal in reading out signals is good or bad.

According to an information reproduction apparatus of claim 1, there is provided the information reproduction apparatus for reproducing information out of a recording medium having information to be reproduced formed on it, including:
a light emission means for emitting light impinged onto the recording medium;

a light receiving means for converging light emitted from the light emission means onto the recording medium and receiving light reflected by the recording medium;

an electrical signal generation means for generating an electric signal from the light reflected by the recording medium and received by the light receiving means;

a radius direction moving means for moving the light receiving means in a radius direction of the recording medium;

a focusing direction moving means for moving the light receiving means in a direction substantially perpendicular to a surface of the recording medium along a radius direction of the recording medium determined with the radius direction moving means;

a calculating means for calculating an electric signal generated by the electric signal generation means out of the light received by the light receiving means which is moved by the focusing direction moving means; and
a radius direction electric signal determining means which determines an electric signal value given to the radius direction moving means on the basis of symmetry of the electric signal, calculated by the calculation means in a moving direction of the light receiving means.

According to an information reproduction method of claim 5, there is provided the information reproduction method for reproducing information reproduced from a recording medium having information to be reproduced formed on it, comprising:
a light emission step of emitting light impinged onto the recording medium;

a light receiving step of converging light emitted from the light emission means onto the recording medium and receiving light reflected by the recording medium;

an electrical signal generation step of generating an electric signal from the light reflected by the recording medium and received in the light receiving step;

a radius direction moving step of moving the position conversing the light converged in the light receiving process in a radius direction of the recording medium;

a focusing direction moving step of moving a focal point of the light thus emitted in a direction substantially perpendicular to a surface of the recording medium along the radius direction of the recording medium determined in the radius direction moving step;

a calculation step of calculating an electric signal generated in the electric signal generation step out of the light received at the focal point which is moved in the focusing direction moving step; and

a radius direction electric signal determination step of determining an electric signal in the radius direction moving step on the basis of symmetry of the electric signal, calculated in the calculation step, in a moving direction of the focal point calculated in the calculation step.

According to an information reproduction program of claim 6, there is provided the information reproduction program causing a computer, included in an information reproduction apparatus for reproducing information from the recording medium for reproducing information out of a recording medium having a plurality of information layers which have information to be reproduced, recorded on it, to function as:

a light emission means for emitting light impinged onto the recording medium;

a light receiving means for converging light emitted from the light emission means onto the recording medium and receiving light reflected by the recording medium;

an electrical signal generation means for generating an electric signal from the light reflected by the recording medium and received by the light receiving means;

a radius direction moving means for moving the light receiving means in a radius direction of the recording medium;

a focusing direction moving means for moving the light receiving means in a direction substantially perpendicular to a surface of the recording medium along a radius direction of the recording medium determined with the radius direction moving means;

a calculating means for calculating an electric signal generated with the electric signal generation means out of the light received by the light receiving means which is moved by the focusing direction moving means; and

a radius direction electric signal determining means which determines an electric signal value given to the radius direction moving means on the basis of symmetry of the electric signal, calculated by the calculation means, in a moving direction of the light receiving means calculated by the light receiving means.

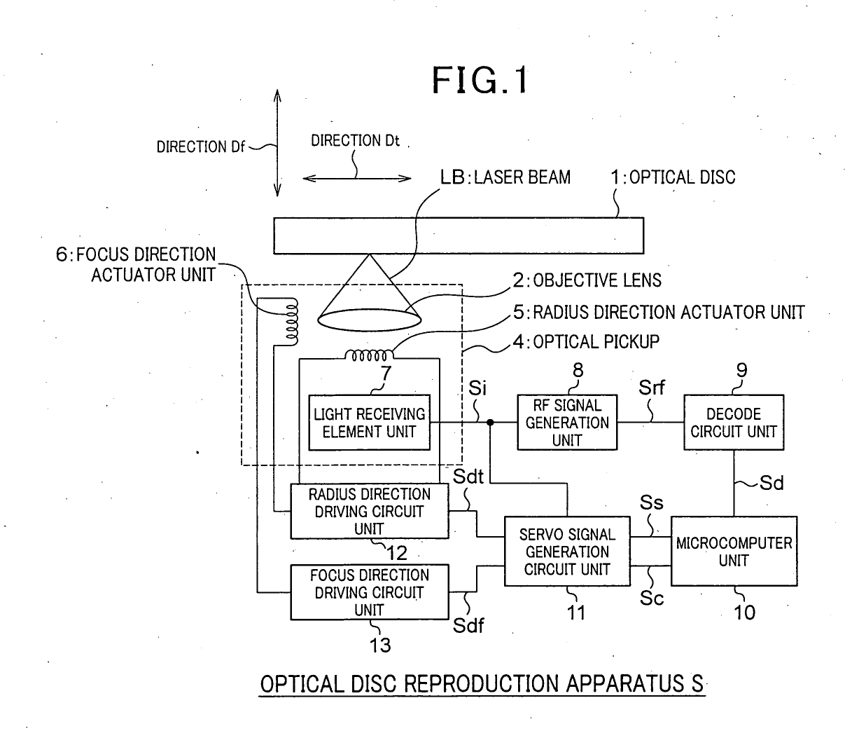

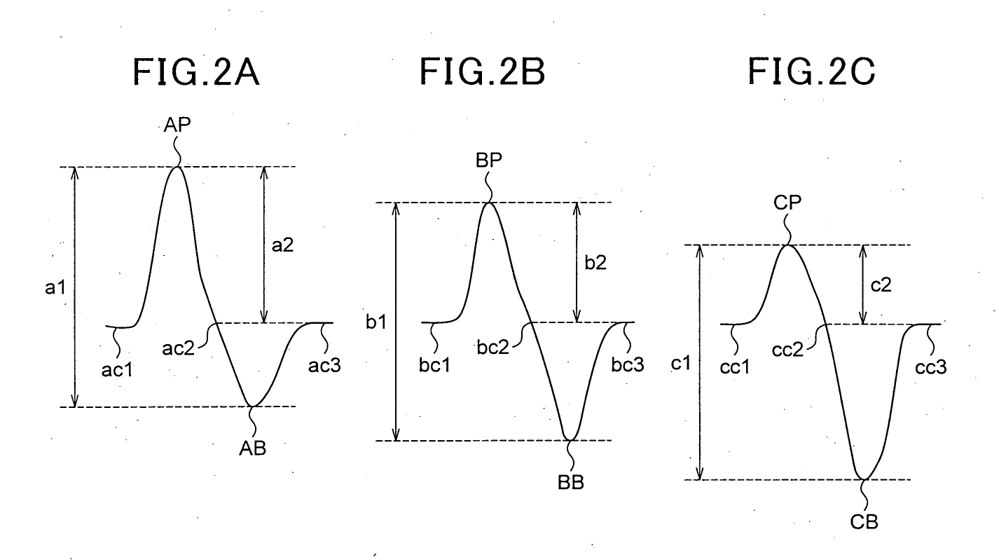

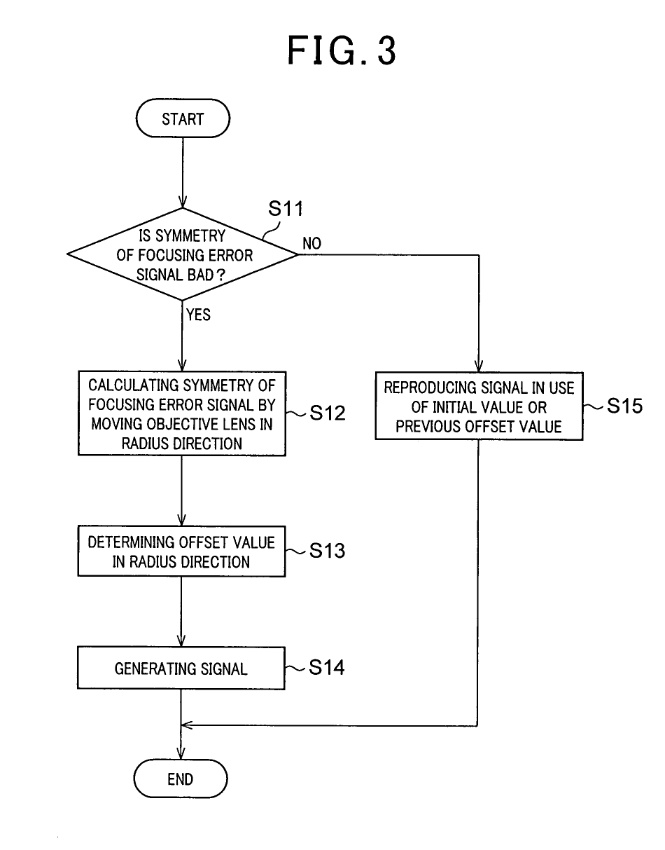

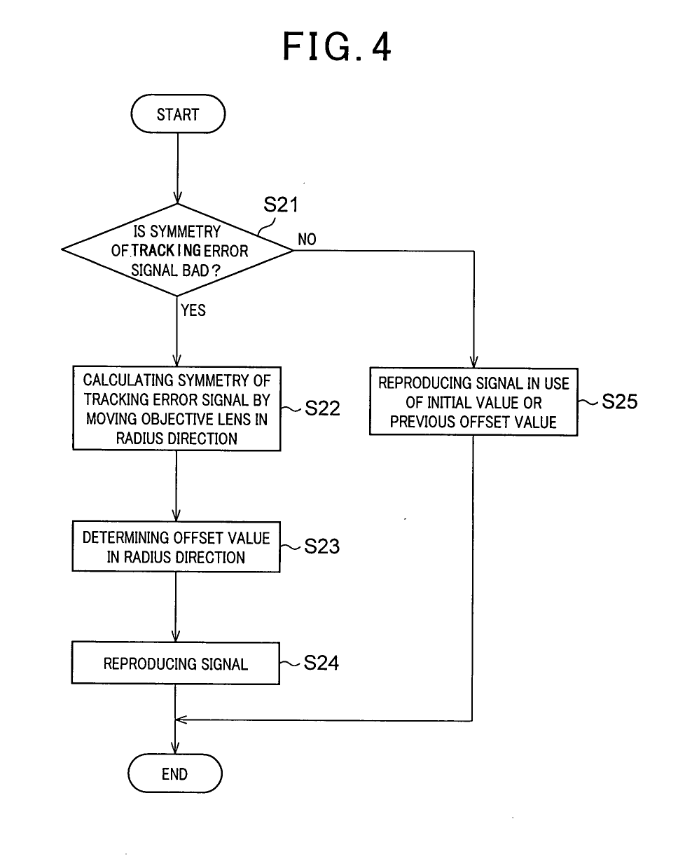

### BRIEF DESCRIPTION OF THE DRAWINGS

[FIG. 1] A block chart for showing a schematic structure of information reproduction apparatus according to the present embodiment.

[FIG. 2] 2A: A figure showing a focusing error signal having deviated symmetry according to the present embodiment; 2B: A figure showing a focusing error signal according to the present embodiment; and 2C: A figure showing a focusing error signal having deviated symmetry according to the present embodiment.

[FIG. 3] A flow chart showing operation of Embodiment 1.

[FIG. 4] A flow chart showing operation of Embodiment 2.

### BEST MODES FOR CARRYING OUT THE INVENTION

Next, an embodiment suitable for the present invention is described in reference of figures.

In the following embodiment related to an optical disk such as DVD, there is described an operation of most suitably adjusting an RF (Radio Frequency) signal level, an RF signal jitter value, symmetry of focusing error signal, or symmetry of tracking error signal by moving an object lens in a track direction in a case where information is picked up out of an information layer having information recorded on it through a pickup.

(1) Total Structure and Operation

First, a total structure of optical record and reproduction apparatus according to the embodiment will be described in reference of FIG. 1.

FIG. 1 is a block chart showing an example of schematic structure of optical disc reproduction apparatus according to the present embodiment. FIG. 2 schematically shows schematic symmetry of focusing error signal.

A schematic operation of the optical disc reproduction apparatus S according to the embodiment is described in reference of FIG. 1. As shown in FIG. 1, a semiconductor laser (not shown), as a light emitting means, inside a pickup 4 (including an objective lens 2 as a light receiving means, a light receiving unit 7 as an electric signal generation means, a radius direction actuator unit 12 as a radius direction moving means, and a focusing direction actuator unit 13 as a focusing direction moving means) emits laser beam LB. Such the laser beam LB is reflected on an information layer of optical disc 1. The laser beam LB thus reflected is changed in response to information on the information layer of the optical disc 1. Such the change is converted into an electric signal Si in the pickup 4. Based on thus converted electric signal Si, in a microcomputer unit 8, as an operation means, a radius direction electric signal determining means, a maximum value detection means, a minimum value detection means, and a determining means, analyses focusing servo information, tracking servo information, a data error rate or the like. In response to the result of analysis, the pickup 4 (or an objective lens OB inside the pickup 4) is moved to a predetermined position.

Next, detailed operation of the optical disc record apparatus S according to the embodiment is described in detail with reference to FIG. 1.

The optical disc record and reproduction apparatus S is constituted by an objective lens OB for irradiating a laser beam LB on an information layer of an optical disc 1 and receiving the laser beam LB reflected on the optical disc 1, a light receiving element unit 7 (pickup 4) fop converting the light thus received to an electric signal Si, an RF signal generation unit 8 for outputting RF (Radio Frequency) signal Srf after amplifying, shaping or processing the electric signal thus inputted, an decode circuit unit 9 for outputting the data signal Sd after decoding the RF signal Srf thus inputted, a decode circuit unit 9 for outputting the data signal Sd by decoding the RF signal thus inputted, a servo signal generation circuit unit 11 for generating servo information signal Ss on the basis of the electric signal Si thus inputted and also generating a radius direction moving signal Sdt and a focusing direction moving signal Sdf, a microcomputer unit 10 for calculating data error rate and jitter value of data on the basis of the servo information signal Sd thus inputted, calculating and judging symmetry of focusing error signal and symmetry of tracking error signal and outputting a servo control signal Sc for controlling a moving direction and moving amount of the objective lens on the basis of the servo information signal Ss thus inputted, and a radius direction driving circuit unit 12 for driving a radius direction actuator unit 12 on the basis of the radius direction moving signal Sdt and causing the objective lens 2 move in a direction substantially parallel to the optical disc 1, being a direction Dt on FIG. 1, and a focusing direction actuator unit 13 for causing the objective lens 2 move in a direction substantially vertical to the optical disk 1, being a direction Df in FIG. 1.

The pickup 4 includes the objective lens 2, the light receiving unit 7, the radius direction actuator unit 12, and the focus direction actuator unit 13.

Next each of the constitutional units is described in detail.

The electric signal Si includes information recorded on an information layer of the optical disc 1, focusing servo information related to a light conversing position of the laser beam LB, and tracking servo information.

For example, the electric signal Si contains the focusing error signal and the tracking error signal, and also information for determining whether or not the pickup 4 is in an appropriate position for reading out information on the information layer of the optical disc 1.

The focusing error signal is information indicative of a positional relationship between a focal point of the light beam LB emitted form the pickup 4 and the information layer of the optical disc. For example, when the focusing error signal is expressed by a so-called astigmatism method, it is represented that the focal point of the light beam LB is closer to the position of the information layer of optical disk as the focusing error signal approaches closer to zero. (in a case where offsets of optical system and electrical system are omitted.)

Further, the tracking error signal is information indicative of a positional relationship in the radius direction of the optical disc 1 between the focal point of the light beam LB and a land track (not shown) or a groove track (not shown) where an information layer is formed to have information. For example, as the tracking error approaches closer to zero, it is represented that the focal point of the light beam LB is closer to a central position in the radius direction of the optical disc 1 (a case where offsets in optical and an electrical systems are omitted)

The RF signal generation unit 8 receives information recorded on the information layer of the optical disc 1 among electrical signals Si indicative of information, which is recorded on the optical disc 1 and indicative of the servo information, excluding the servo information. Although the electrical signal Si is a minute signal, it is outputted as an RF signal Srf which can be handled in the decode circuit unit 9 in the later stage by amplifying and shaping inside the RF signal generation unit 8.

The servo signal generation circuit unit 11 receives the electric signal Si indicative of the servo information and the servo control signal Sc. The tracking error signal contained in the servo information is a servo signal in a tracking servo circuit constituted by the light receiving unit 7, the servo signal generation circuit unit 11 and the radius direction driving circuit unit 12. Further, the focusing error signal contained in the servo information is the servo signal in a focusing servo circuit constituted by the light receiving element unit 7, the servo signal generation circuit unit 11 and the focusing direction driving circuit unit 13.

The servo signal generation circuit unit 11 sets up an amplifying rate of electric signal Si indicative of the servo information, and adjusts the servo characteristics such as phase and frequency band used in the servo circuit.

Further, it functions to set a residual signal excluding an offset signal in the servo circuit zero. The offset signal is determined base on the servo control signal Sc outputted from the microcomputer unit 10.

Further, the servo circuit of the servo signal generation circuit unit 11 contains the tracking servo circuit and the focusing servo circuit. The servo signal generation circuit unit 11 closes and opens the servo circuit. These open and close operations of the servo circuit are realized by opening and closing a switch circuit such as an analogue switch contained in the servo signal generation circuit unit 11 on the basis of the servo control signal Sc.

The track servo circuit and the focus servo circuit respectively have a switching circuit. Accordingly, by outputting the radius direction movement signal Sdt after opening the focusing servo circuit while applying the tracking servo, it is possible to carry out the focus search operation. In this case, by moving the focal point of objective lens in a direction Df substantially perpendicular to the optical disc 1 to thereby transverse the information layer, a focusing error signal of so-called S curve characteristics shown in FIG. 2 is obtainable.

Further, by opening the tracking servo circuit while applying focus servo to thereby output a focus direction movement signal Sdf, it is possible to carry out track cross operation. In this case, by moving the focal point of objective lens in a direction Dt substantially parallel to the optical disc 1 to thereby cause the focal point of objective lens transverse a land groove or a groove track formed on the optical disk, it is possible to obtain the track error signal.

The radius direction driving circuit unit 12 amplifies the radius direction movement signal Sdt outputted from the servo signal generation circuit unit 11 and outputs electric current to the radius direction actuator unit 5. The objective lens 2 is moved in a direction Dt in response to an electric current value applied to the radius direction actuator unit 5.

The focus direction driving circuit unit 13 amplifies the focus direction movement signal Sdf outputted from the servo signal generation circuit unit 11 and outputs an electric current to the focus direction actuator unit 6. The objective lens 2 is moved in a direction Df in response to an electric current value applied to the focus direction actuator unit 6.

The decode circuit unit 9 receives an RF signal Srf generated by the RF signal generation circuit unit 8. Since the RF signal Srf is an encode signal having error correction information or the like attached, it is impossible to use it as an ordinary data signal without decoding the same. By carrying out a decode process with the decoding circuit unit 9, it becomes data signal Sd which can be processed as data information such as image signal or audio signal. The decode circuit unit 9 outputs the data signal Sd by processing the RF signal thus inputted.

Further, a signal level indicative of magnitude of RF signal is detected, and the signal level information is outputted after incorporating the information into the data signal Sd. Further, jitter information is detected as error information in a time axis direction of the RF signal. Such the jitter information is outputted after incorporating it into the data signal Sd. Further, the data error rate is calculated in converting it into the data signal, and the data error rate is outputted while incorporating it into the data signal Sd.

The data signal Sd is inputted into the microcomputer unit 8. The microcomputer unit 8 outputs the servo control information Sc on the basis of data signal quality information such as signal level information, jitter information and data error rate, which are contained in the data information based on the data signal Sd to thereby cause position of the objective lens 2 move in order to determine the position of the objective lens 2 related to the most suitable signal quality.

For example, an offset voltage causing the data signal quality information most suitable is detected while changing the offset voltage applied to the tracking servo circuit in the servo signal generation circuit unit 11. Thereafter, the most suitable offset voltage value is set up in the tracking servo circuit in reading out data to thereby cause to read out information recorded on the information layer of optical disc.

Specifically, while the objective lens 2 is moved in a radius direction by 0.1 mm, 0.2 mm . . . in the radius direction with respect to the light axis of the laser beam LB to be deviated from the light axis, the offset voltage is outputted as tracking servo control information. Then the signal level information, the jitter information, and the data error rate with respect to each of the offset voltage values are measured. In other words, an offset voltage value causing the maximum signal level, an offset voltage value causing the minimum jitter (e.g. the minimum jitter in 3T signal), and an offset voltage value causing the minimum data error rate are detected.

In a case where the offset voltage values causing the most suitable signal qualities (the maximum signal level, the minimum jitter level, and the minimum data error rate) are detected, the offset voltage value is set up in the servo signal generation circuit. The offset voltage value causing the maximum signal level, the offset voltage value causing the minimum jitter, and the offset voltage value causing the minimum data error rate do not always match each other. Therefore, the microcomputer unit 10 works to read out information formed in the optical disc 1 by setting up the offset voltage value related to any of the signal qualities in the servo signal generation processing circuit.

The servo information signal Ss is inputted into the microcomputer unit 8. The focusing error signal and the tracking error signal are contained in the servo information signal.

The microcomputer unit 8 determines a position of the objective lens 2 indicative of symmetry of the most suitable focusing error signal and symmetry of the tracking error signal while moving the position of the objective lens 2.

For example, it is possible to detect the offset voltage value indicative of the symmetry of the most suitable focusing error signal and the symmetry of the tracking error signal while changing the offset voltage value applied to the tracking servo circuit in the servo signal generation circuit unit 11. Thereafter, in reading out data, the most suitable offset voltage value is set up in the tracking servo circuit to thereby read out information recorded on the information layer of the optical disc.

Here, the symmetry of the focusing error signal is described in reference of FIG. 2. FIG. 2B shows a state that symmetry of focusing error signal is most suitable. In FIG. 2B, the symmetry of focusing error signal is represented by the following formula (1).

### (Formula 1)

(b1/b2)×100(%) (1)

As the value of Formula 1 approaches closer to 50%, the symmetry of the focusing error signal is more suitable. In the focusing error signal of FIG. 2B, the value of the Formula (1) is 50%, indicative of the most suitable focusing error signal.

Here a position bc1, a position bc2, and a position bc3 in the focusing error signal in FIG. 2B represent identical positions of focusing error signal level. In a case where a value of Formula (1) is 50%, a position BP representing the maximum value of the focusing error signal and a position BB representing the minimum value of the focusing error signal become points existing in symmetrical positions with respect to signal levels of the positions bc1, bc2, and bc3, as a center.

In a case of such the focusing error signal, it is possible to read out information formed on the information layer of the optical disc 1 in a condition where the focusing servo is most stable since a stable tracking servo is applied by maximizing a margin (flexibility) of the tracking error signal in a direction from the position of the objective lens corresponding to the positions bc1, bc2, and bc3 to a position BP and a margin (flexibility) of the tracking error signal in a direction from the position of the objective lens to a position BB.

The focusing error signal in FIG. 2A, the value of Formula (1) is about 66%, which designates a case where symmetry of the focusing error signal is deviated.

In this, positions ac1, ac2 and ac3 in the focusing error signal in FIG. 2A represent identical focusing error signal level positions. In a case where the value of Formula (1) becomes 66%, a position AP indicative of the maximum value of the focusing error signal exists at a position deviated by about 33% on a side of the position AP with respect to a position AB indicative of the minimum value of the focusing error signal.

In this case, there are indicated that the tracking servo has a margin with respect to a direction to the position AP, and does not have a margin in a direction to the position AB. Accordingly, when the objective lens 2 is moved on a side of the position AB of the focusing error signal, the focusing servo is apt to be unstable thereby easily causing inappropriate focusing servo and deviation of focusing servo. Therefore, the information formed on the information layer of the optical disc 1 is apt to be unstably read out.

The focusing error signal in FIG. 2C has a value of about 33%, wherein it is indicated that symmetry of the focusing error is deviated.

In this, positions cc1, cc2, and cc3 in the focusing error signal in FIG. 2C represent identical focusing error signal level positions. In a case where a value of Formula (1) becomes 33%, a position CB indicative of the minimum value of the focusing error signal exists about 33% deviated on a side of the position CB in comparison with a position CP indicative of the maximum value of focusing error signal with respect to the signal levels of the positions cc1, cc2, and cc3 as a center.

In this case, the tracking servo has a margin in the direction to the position CB but has not a margin in the direction to the position CP. Accordingly, in a case where the objective lens 2 moves on a side of the position CP of the focusing error signal, the focusing servo is apt to be unstable. Therefore, it is apt to occur a case where the focusing servo does not appropriately work or the focusing servo deviates whereby it is apt to occur that information formed on an information layer is not stably read out.

As such the microcomputer unit 10 detects an offset voltage value corresponding to a value in an occasion that the value indicative of the symmetry of the focusing error value approaches 50% while changing the offset voltage value applied to the tracking servo circuit in the servo signal generation circuit unit 11, as a most suitable offset value. Thereafter, at a time of reading out the data, the most suitable offset value is set up into the tracking servo circuit to thereby read out information recorded on the information layer of the optical disc.

Specifically, the objective lens 2 is moved in the radius direction as many as 0.1 mm, 0.2 mm, . . . with respect to the light axis of the laser beam LB to thereby obtain the offset voltage value as the tracking servo signal control information as the objective lens is deviated from the light axis and measure a value indicative of the symmetry of the focusing error signal with respect to each of the offset voltage values. In other words, the offset voltage value corresponding to an occasion that the value indicative of the symmetry of the focusing error signal is closet to 50%.

Further, as for the tracking error signal, since a waveform similar to the focusing error signal in FIG. 2 is obtainable by applying the offset voltage value to the tracking servo circuit, it is possible to detect the offset voltage value corresponding to a position most suitable for the symmetry can be detected.

As described above, the microcomputer unit 10 changes the tracking offset voltage value to move the objective lens 2 in the radius direction. Thus it carries out an operation of detecting the offset voltage value for causing signal quality most suitable (the maximum signal level, the minimum jitter level, and the minimum data error rate), and an operation of detecting the offset voltage value for causing the symmetry of the focusing error and the tracking error signal most suitable. Under a state that the offset voltage value thus detected is set up in the servo signal generation circuit unit 11, an operation of reading information formed on the information layer out of the optical disc 1 is carried out.

### (II) First Embodiment of the Present Invention

Next, the embodiment is described in reference of FIG. 3. The embodiment is to explain an operation of the optical disc reproduction apparatus S which obtains the most suitable offset voltage value in use of symmetry of a focusing error signal.

Next, operation of each of the steps is described.

In Step S11, the microcomputer unit 10 judges whether or not the symmetry of focusing error signal in the optical disc apparatus S is bad as shown in FIG. 2A or 2C. The focusing error signal is contained in the servo information signal Ss.

In a case where the microcomputer unit 10 judges that the symmetry of the focusing error signal is bad (Step S11: YES), the process goes to Step S12. In a case where the microcomputer unit 10 judge that symmetry of the focusing error signal is good (the above-mentioned case where symmetry of the focusing error signal is 50% or a value close to 50%) (Step S11: NO), the process goes to Step S15.

Next, in Step S12, the microcomputer unit 10 outputs the servo information signal Ss to cause the objective lens 2 move in a radius direction. After moving the objective lens 2 in the radius direction of the optical disk 1, the objective lens is moved in a direction Df in FIG. 1 to thereby output the servo control signal Sc so that a focal point of the objective lens 2 passes through an information layer of the optical disc.

In this case, the objective lens 2 may be moved in a direction from a surface of the optical disc 1 to a back surface of the optical disc 1, or the objective lens 2 may be moved in a direction from the back surface of the optical disc 1 to the surface of the optical disc 1. By moving the objective lens 2 as such, the focusing error signal shown in FIG. 2 is inputted into the microcomputer unit 10 in a state that the focusing error signal shown in FIG. 2 is inputted into the microcomputer unit 10.

The micro computer unit 10 calculates symmetry of the focusing error signal thus inputted on the basis of Formula (1). Next, by further moving the objective lens 2 in the radius direction, the microcomputer unit 10 calculates the symmetry of the focusing error signal on the basis of the Formula (1) in a manner similar thereto. This operation is repeated as many as about several times to several tens of times and a value indicative of the symmetry of the focusing error signal with respect to each of the offset voltages for moving the objective lens 2 in the radius direction is calculated.

Further, in Step S13, the microcomputer unit 10 searches a value most close to 50% out of values representing symmetry of the focusing error signals thus calculated. A value of the servo information signal Sc corresponding to the radius direction offset voltage value in a case where the value indicative of the symmetry of the focusing error signal is closest to 50% is determined as the most suitable offset voltage value.

Then in Step S14, the servo signal control signal Sc is outputted from the microcomputer unit 10 so that the offset value in the radius direction becomes the most suitable offset value. Then the information is read out of the optical disk 1.

Further, in Step S15, the microcomputer unit 10 outputs the servo information signal Sc in use of a value contained in the servo information signal Sc corresponding to an offset initial voltage value in the radius direction or a value corresponding to a most suitable offset value in the previous time, these voltage values being written into a memory unit such as non-volatile RAM (Random Access Memory) provided in the microcomputer unit 10. Then information formed in the information layer of the optical disc 1 is read out.

According to such the construction, it is possible to correct scattering in assembling various constitutional elements, whereby the most suitable offset voltage value is obtainable. Accordingly, it becomes possible to read out information by reading out information from the optical disk 1 in use of the most suitable offset value to thereby enabling stable read-out of the information. Further, the servo characteristics thus stabilized make signal quality of the RF signal Srf thus read out improve.

Further, after a test of circumstance before delivering the information reproduction apparatus S, even though mechanical positional deviations of the constitutional elements occur, the information reproduction apparatus S detects the most suitable offset value, and controls the servo signal generation circuit unit 11 to output the most suitable offset value. Accordingly, it becomes possible to read out information by stabilizing the servo characteristics. Further, by stabilizing the servo characteristics, the signal quality of the RF signal thus read out is improved.

Furthermore, even though the mechanical deviation of each of the constitutional elements occur in accordance with secular change after delivering the information reproduction apparatus S, the information reproduction apparatus S detects the most suitable offset value and controls the servo signal generation circuit unit 11 so as to output the most suitable offset voltage value. Accordingly, by reading the information out of the optical disk 1, it becomes possible to read out the information by stabilizing the servo characteristics. Furthermore, by stabilizing the servo characteristics, the signal quality of the RF signal Srf thus read out is also improved.

Meanwhile, it is possible to cause a general-purpose microcomputer to function as a CPU related to the embodiment by previously recording the program corresponding to the flow chart of FIG. 3 on a flexible disc, previously recording the program through a network such as internet, and reading-out and executing it with the general-purpose microcomputer.

In the Embodiment, an offset voltage value is obtained in a case where symmetry of focusing error signal is good. However, the present invention is not limited thereto and it is possible to make an offset value in a radius direction causing a data error rate minimum and an RF signal Srf maximum in a case where the focusing error signal has good symmetry.

### (III) Second Embodiment of the Present Invention

Next, the embodiment of the present invention is described in reference of FIG. 4. The embodiment is that describing an operation of the optical disc reproduction apparatus S for obtaining a most suitable track offset voltage value in use of symmetry of tracking error signal.

Next, the operation is described with respect to each of the steps.

In Step S21, it is judged in the optical disc reproduction apparatus S whether symmetry of tracking error signal having a shape similar to the focusing error signal shown in FIG. 2A or 2C is good or bad by calculation of a servo information signal Ss in the microcomputer unit 10. The tracking error signal is contained in the servo information signal Ss.

When the microcomputer unit 10 judges that the symmetry of the tracking error signal is bad along YES in Step S21, the process goes to Step S22. In a case where the microcomputer unit 10 judges that the symmetry of the tracking error signal is good (the symmetry of the tracking error signal is 50% or an value close to 50%) along NO in Step S21, the process goes to Step S25.

Next, in Step S22, the microcomputer unit 10 outputs the servo information signal Ss to move the objective lens 2 in a radius direction. After the objective lens 2 is moved in the radius direction of the optical disc 1, the objective lens 2 is moved in the direction Dt in FIG. 1 to thereby output the servo control signal Sc so that the focal point passes through land track or groove track on the optical disc 1.

In this case, the objective lens 2 may be moved in a direction of a periphery of optical disc from a center portion of the optical disc 1. Or the objective lens 2 may be moved in a direction from a periphery of the optical disc 1 to a center portion of the optical disc. By thus moving the objective lens 2, the tracking error signal is inputted into the microcomputer unit 10 in a condition that the tracking error signal similar to the focusing error signal shown in FIG. 2 is included in the servo information signal Ss.

In the microcomputer unit 10, the symmetry of the tracking error signal thus inputted is calculated on the basis of Formula (1). Next, the objective lens 2 is further moved in the radius direction to thereby cause the microcomputer unit 10 calculate the symmetry of the tracking error signal on the basis of the Formula (1). This operation is repeated by as many as about several times to several tens of times and a value indicative of the symmetry of the tracking error signal is calculated with respect to the each of the offset voltages for moving the objective lens 2 in the radius direction.

Further, in Step S23, the microcomputer unit 10 searches for a value most close to 50% out of values representing the symmetry of the tracking error signal thus calculated. The value of the servo information signal Sc corresponding to the offset value in the radius direction is determined as a most suitable offset voltage value corresponding to the radius direction offset voltage value in a case where the value indicative of the symmetry of the tracking error signal is closest to 50%.

In Step S24, the servo signal control signal Sc is outputted so that the offset value in the radius direction becomes the most suitable offset value. Then the information is read out of the optical disc 1.

As such, it is possible to obtain the most suitable offset voltage value for correcting scattering of each of the constitutional elements of the optical pickup 4. Accordingly, it becomes possible to read out the information with the servo characteristics stabilized by reading out the information from the optical disk 1 in use of the most suitable offset voltage value. Further, signal quality of the RF signal thus read out is improved by stabilizing the servo characteristics.

Meanwhile, the program corresponding to the flowchart of FIG. 4 may be previously recorded in a flexible disc or inside a network such as internet. It is possible to read out and execute the program by a general-purpose microcomputer or the like to thereby function the general-purpose microcomputer or the like as a CPU related to the Embodiment.

Further, in the present embodiment, the offset voltage value is obtained in a case where the symmetry of the tracking error signal is good. The present invention is not limited thereto and it is possible to make an offset value in a radius direction causing the data error rate minimum and the RF signal Srf maximum in a case where the symmetry of the tracking error signal is good.

As described above, the information reproduction apparatus described in the Embodiment is to reproduce information out of an optical disc having the information to be reproduced recorded on it. In the information reproduction apparatus, there is provided

a semiconductor laser device for emitting light to be impinged onto the recording medium,

an objective lens for converging the light emitted from the semiconductor laser device onto the optical disc and simultaneously receiving the light emitted from the semiconductor laser,

a light receiving element unit for generating an electrical signal from the light reflected by the optical disc and received by the objective lens,

a radius direction actuator unit for moving the objective lens in a radius direction of the optical disc,

a focusing direction actuator unit for moving the objective lens in a direction substantially perpendicular to a surface of the recording medium along a radius direction of the optical disc predetermined by the radius direction actuator unit,

a microcomputer unit for calculating the electrical signal generated by the focusing direction actuator out of the light received by the objective lens which is moved by the focusing direction actuator unit, and

a microcomputer unit for determining an electric signal value to be applied to the radius direction actuator unit on the basis of the symmetry of the electric signal in the moving direction of the light receiving means which calculated by the microcomputer unit.

According to this structure, it is possible to obtain the most suitable offset voltage value for correcting scattering in assembling constitutional elements of the optical pickup 4. Accordingly, by reading out the information from the optical disc 1 in use of the most suitable offset voltage value, it becomes possible to readout the information with the servo characteristics stabilized. Further, by stabilizing the servo characteristics a signal quality of the RF signal thus read out is improved.

Further, after an environmental testing before delivering the information reproduction apparatus S, even though mechanical deviation of the constitutional elements occur inside the pickup 4, the information reproduction apparatus S detects the most suitable offset voltage value and controls the servo signal generation circuit unit 11 to thereby output the most suitable offset voltage value. Accordingly, it becomes possible to read out the information by stabilizing the servo characteristics. Further, by stabilizing the servo characteristics, the signal quality of the RF signal thus read out is also improved.

Further, in a case where mechanical deviation of the constitutional elements inside the pickup 4 is generated by secular change after delivering the information reproduction apparatus S, the information reproduction apparatus S detects the most suitable offset voltage value and controls the servo signal generation circuit unit 11 so as to output the most suitable offset voltage value. Accordingly, it becomes possible to read out the information by stabilizing the servo characteristics. Further, since the servo characteristics are stabilized, the signal quality of the RF signal Srf thus read out is improved.

Further, the information reproduction apparatus according to the embodiment in the information reproduction apparatus according to Claim 1 is provided with a microcomputer unit for detecting a maximum value of an electric signal generated by the light receiving element unit in receipt of light obtained through the objective lens while moving the focusing direction actuator, a microcomputer unit for detecting a minimum value of the electric signal generated by the light receiving element unit in receipt of light obtained through the objective lens while moving the focusing direction actuator, a microcomputer unit for determining characteristics of the electric signal on the basis of absolute values of the maximum value and the minimum value, and a microcomputer unit for determining the electric signal value to be given to the radius direction actuator unit on the basis of the value obtained by the microcomputer unit.

According to the structure, it is possible to obtain the most suitable offset voltage value for correcting scattering in assembling each constitutional elements of the optical pickup 4. Accordingly, it becomes possible to read out the information out of the optical disc 1 in use of the most suitable offset voltage value. Further, the signal quality of the RF signal Srf thus read out is improved by stabilizing the servo characteristics.

Furthermore, the information reproduction apparatus according to the embodiment in the information reproduction apparatus according to Claim 1 is provided with a microcomputer unit for detecting a maximum value of an electric signal generated by the light receiving element unit in receipt of light obtained through the objective lens while moving the radius direction actuator, a microcomputer unit for detecting a minimum value of the electric signal generated by the light receiving element unit in receipt of light obtained through the objective lens while moving the radius direction moving actuator, a microcomputer unit for determining characteristics of the electric signal on the basis of absolute values of the maximum value and the minimum value, and a microcomputer unit for determining the electric signal value to be given to the radius direction actuator unit on the basis of the value obtained with the microcomputer unit.

According to the structure, it is possible to obtain the most suitable offset voltage value for correcting scattering in assembling each of the constitutional elements of the optical pickup 4. Accordingly, by reading out the information in use of the most suitable offset voltage value, the servo characteristics can stably be read out. Further, the signal quality of the RF signal Srf thus readout is improved by stabilizing the servo characteristics.

Further, the information reproduction apparatus according to the embodiment in the information reproduction apparatus according to claim 2 or 3 is provided with a decode circuit unit for decoding the electric signal generated by the light receiving unit, a microcomputer unit for calculating an error rate of information generated with the decode circuit unit, and a microcomputer unit for determining a signal applied to the radius direction actuator unit to thereby minimize the error rate calculated with the microcomputer unit.

According to the structure, the most suitable offset voltage value for correcting scattering in assembling each of the constitutional elements of the optical pickup 4 is obtainable. Accordingly, it becomes possible to readout the information while stabilizing the servo characteristics by reading out the information out of the optical disk 1 in use of the most suitable offset voltage value. Further, the signal quality of the RF signal thus read out is improved by stabilizing the servo characteristics.

Furthermore, according to the structure, since the RF signal Srf determines position of objective lens of making the Rf signal Srf good in a case where the servo characteristics are stable, the signal quality of the RF signal Srf thus read out is improved.

1. An information reproduction apparatus for reproducing information out of a recording medium having information to be reproduced formed on it, comprising:
a light emission device which emits light impinged onto the recording medium;
a light receiving device which converges light emitted from the light emission device onto the recording medium and receiving light reflected by the recording medium;
an electrical signal generation device which generates an electric signal from the light reflected by the recording medium and received by the light receiving device;
a radius direction moving device which moves the light receiving device in a radius direction of the recording medium;
a focusing direction moving device which moves the light receiving device in a direction substantially perpendicular to a surface of the recording medium along a radius direction of the recording medium determined with the radius direction moving device;
a calculating device which calculates an electric signal generated by the electric signal generation device out of the light received by the light receiving device which is moved by the focusing direction moving device; and
a radius direction electric signal determining device which determines an electric signal value given to the radius direction moving device on the basis of symmetry of the electric signal, calculated by the calculation device in a moving direction of the light receiving device.

2. The information reproduction apparatus according to claim 1, further comprising:
a maximum value detection device which detects a maximum value of the electric signal which is generated with the electric signal generation means device out of the light obtained by the light receiving device, which is moved by the focusing direction moving device;
a minimum value detection device which detects a minimum value of the electric signal which is generated by the electric signal generation device out of the light obtained by the light receiving device, which is moved by the focusing direction moving device;
a determining device which judges characteristic of the electric signal on the basis of an absolute value of the maximum value and an absolute value of the minimum value; and
the electric signal determining device which determines the electric signal value to be given to the radius direction moving device on the basis of the value obtained by the determining device.

3. The information reproduction apparatus according to claim 1 comprising:
a maximum value detection device which detects a maximum value of the electric signal, which is generated with the electric signal generation device, out of the light obtained by the light receiving device which is moved by the radius direction moving device;
a minimum value detection device which detects a minimum value of the electric signal, which is generated with the electric signal generation device, out of the light obtained by the light receiving device which is moved by the radius direction moving device;
a determining device which judges characteristic of the electric signal on the basis of an absolute value of the maximum value and an absolute value of the minimum value; and
an electric signal determining device which determines an electric signal value to be given to the radius direction moving device on the basis of the determining device.

4. The information reproduction apparatus according to claim 2, comprising:
a decode device which decodes the electric signal generated with the electric signal generation device;
an error rate calculation device which calculates an error rate of information generated with the decode device; and
an electric signal determining device which determines a signal applied to the radius direction moving device to make the error rate calculated by the error rate calculation device minimum.

5. An information reproduction method for reproducing information reproduced from a recording medium having information to be reproduced formed on it, comprising:
a light emission step of emitting light impinged onto the recording medium;
a light receiving step of converging light emitted from the light emission device onto the recording medium and receiving light reflected by the recording medium;
an electrical signal generation step of generating an electric signal from the light reflected by the recording medium and received in the light receiving step;
a radius direction moving step of moving the position conversing the light converged in the light receiving process in a radius direction of the recording medium;
a focusing direction moving step of moving a focal point of the light thus emitted in a direction substantially perpendicular to a surface of the recording medium along the radius direction of the recording medium determined in the radius direction moving step;
a calculation step of calculating an electric signal generated in the electric signal generation step out of the light received at the focal point which is moved in the focusing direction moving step; and
a radius direction electric signal determination step of determining an electric signal in the radius direction moving step on the basis of symmetry of the electric signal, calculated in the calculation step, in a moving direction of the focal point calculated in the calculation step.

6. An information reproduction program causing a computer, included in an information reproduction apparatus for reproducing information from the recording medium for reproducing information out of a recording medium having a plurality of information layers which have information to be reproduced, recorded on it, to function as:
a light emission device which emits light impinged onto the recording medium;
a light receiving device which converges light emitted from the light emission device onto the recording medium and receiving light reflected by the recording medium;
an electrical signal generation device which generates an electric signal from the light reflected by the recording medium and received by the light receiving device;
a radius direction moving device which moves the light receiving device in a radius direction of the recording medium;
a focusing direction moving device which moves the light receiving device in a direction substantially perpendicular to a surface of the recording medium along a radius direction of the recording medium determined with the radius direction moving device;
a calculating device which calculates an electric signal generated with the electric signal generation device out of the light received by the light receiving device which is moved by the focusing direction moving device; and
a radius direction electric signal determining device which determines an electric signal value given to the radius direction moving device on the basis of symmetry of the electric signal, calculated by the calculation device, in a moving direction of the light receiving device calculated by the light receiving device.

7. An information recording medium having the information reproduction program according to claim 6 recorded on it in a manner readable by a computer.
